(19) United States
(12) Patent Application Publication
(10) Pub. No.: US 2015/0083555 A1
(43) Pub. Date: Mar. 26, 2015

(54) POSITION LOCK FOR ELECTRICAL CONTROL DEVICES

(71) Applicant: David M. Nickels, Deshler, OH (US)

(72) Inventor: David M. Nickels, Deshler, OH (US)

(21) Appl. No.: 14/491,988

(22) Filed: Sep. 20, 2014

Related U.S. Application Data
(60) Provisional application No. 61/880,471, filed on Sep. 20, 2013.

(51) Int. Cl. H01H 9/28

(52) U.S. Cl. CPC H01H 9/283
USPC 200/43.15

(57) ABSTRACT

Position locks for electrical control devices are described. One embodiment includes a lock that is retrofitted onto existing electrical control devices. The lock has a mounting member that is attached to both the electrical control device and a pivoting member that can swing over the handle of the electrical control device. When the shackle of a padlock is used to secure the pivoting member in place, the handle of the electrical control device cannot be turned or pushed in, preventing accidental closing of the circuit. Also described is a lock that is created from a tube that has a slit in the side that allows the lock to be slid around the handle of the electrical control device and apertures for receiving the shackle of a padlock to secure the lock in place, thereby preventing accidental closing of the circuit.

### RELATED APPLICATIONS

This application is claiming the benefit, under 35 U.S.C. §119(e), of the provisional application filed on Sep. 20, 2013, under 35 U.S.C. §111(b), which was granted Ser. No. 61/880,471, and is hereby incorporated by reference in its entirety.

### FIELD OF THE INVENTION

The present invention relates to a position lock for electrical control devices.

### BACKGROUND OF THE INVENTION

In a circuit breaker, or other electrical control device, the OFF state, TEST state, and ON state are quite important. For example, maintenance personnel often use a circuit breaker or other electrical control device to interrupt the flow of electrical energy through a circuit when the circuit, or electrical components connected thereto, require maintenance. The circuit breaker or other electrical control device, however, is often remote from the location requiring maintenance. Therefore, it is desirable to lock the position of the circuit breaker or other electrical control device to prevent an individual from inadvertently energizing the circuit while maintenance is being performed.

In draw-out circuit breakers and other electrical control devices, the ON state requires that the handle of the device be pushed in and turned in a specified position, whereas the OFF state requires that the handle be pulled out and turned to a different position. In order to safely lock a draw-out circuit breaker or other electrical control device in the OFF position so that maintenance workers can proceed with their work, it is desirable to have a lock that prevents the handle from being pushed in or turned.

Some circuit breakers or other electrical control device are manufactured to include a lock in the handle so that only a person with a key can change the position of the handle. However, this type of device has several drawbacks. First, it requires that the user has a correct, functional key in order to lock the position of the handle, which can be logistically difficult, especially in an emergency. Second, such a system of locks is only effective if all the electrical control devices are of the keyed handle type, which may require replacement of existing non-keyed electrical control devices which is costly.

Preferably, either a simple, inexpensive lock can be retrofitted onto existing electrical control devices or the people involved in maintenance of the circuit, or electrical components connected thereto, could carry a portable lock that can be used on electrical control devices commonly seen in their field of work. The embodiments of the current invention describe position locks that achieve both of these goals.

### SUMMARY OF THE INVENTION

The present invention is directed to position locks for n electrical control device, which are structurally simple, reliable, convenient to operate, and can prevent mis-operation, and lowers the costs for manufacturing, installing, and maintaining the device.

In accordance with one of the embodiments of the invention, a position lock for an electric control device would contain a mounting member; a pivoting member, and apertures for receiving a shackle of a padlock disposed within the pivoting member. The pivoting member can rotate along a single axis in relation to the mounting member. The pivoting member may be U-shaped and is of a sufficient length to be able to swing over handle of the electrical control device being locked.

In accordance with another of the embodiments of the invention, a position lock for an electric control device made from a tube that contains a slit and apertures for receiving a shackle of a padlock is described. The tubular lock may also have a notch for receiving the handle of the device being locked.

### BRIEF DESCRIPTION OF THE DRAWINGS

The above, as well as other advantages of the present invention, will become readily apparent to those skilled in the art from the following detailed description when considered in the light of the accompanying drawings in which:

FIG. 1 is a photograph of one embodiment of a position lock.

FIG. 2 is a photograph of the lock shown in FIG. 1 as it would be mounted on an electrical control device and positioned to prevent the handle of the electrical control device from being turned when the lock is secured in place.

FIG. 3 is a photograph of the lock shown in FIG. 1 as it would be mounted on an electrical control device and positioned to allow the handle of the electrical control device to be turned.

FIG. 4 is a photograph of an alternative embodiment of a position lock.

FIG. 5 is a photograph of the lock of FIG. 4 as it would be placed on an electrical control device and positioned to prevent the handle of the electrical control device from being turned when the lock is secured in place.

FIG. 6 is a photograph of the lock of FIG. 4 as it would be secured in place with a padlock.

### DETAILED DESCRIPTION OF THE PREFERRED EMBODIMENTS

In order to make the technical features, objectives, and efficacies of the present invention more comprehensible, a detailed description of embodiments is given below in conjunction with the drawings in which the same member has the same reference numeral.

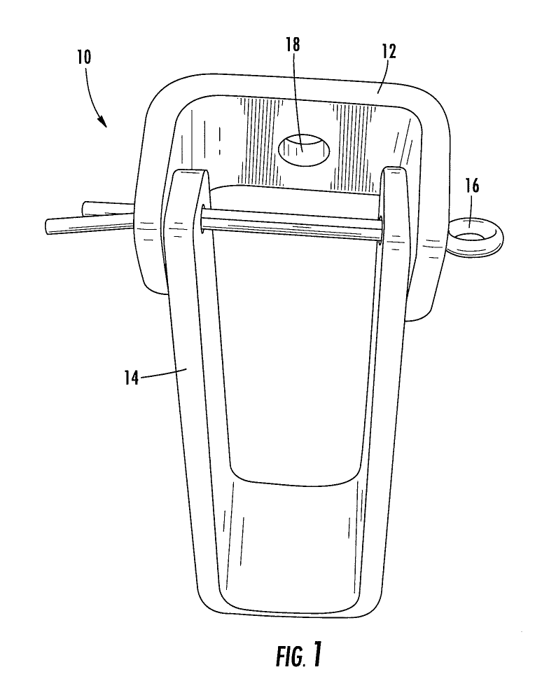

FIG. 1 shows one embodiment of a position lock 10. The lock 10 is comprised of a mounting member 12 and a pivoting member 14. As shown, the lock 10 may have a pin 16 that attaches the mounting member 12 and pivoting member 14 to each other, although any means of attachment that allows the pivoting member 14 to move rotationally about one axis in relation to mounting member 12 is contemplated by this invention. If a pin 16 is used as the means of attachment between the mounting member 12 and the pivoting member 14, the pin 16 will be disposed in pairs of apertures (not visible in these figures) in both the mounting member 12 and pivoting member 14, where the pairs of apertures are aligned to receive the pin 16. The mounting member 12 may have an additional aperture 18 through which a mounting screw (not shown) may be used to mount the lock 10 to an electrical control device (an example of which is shown as reference number 20 in subsequent figures).

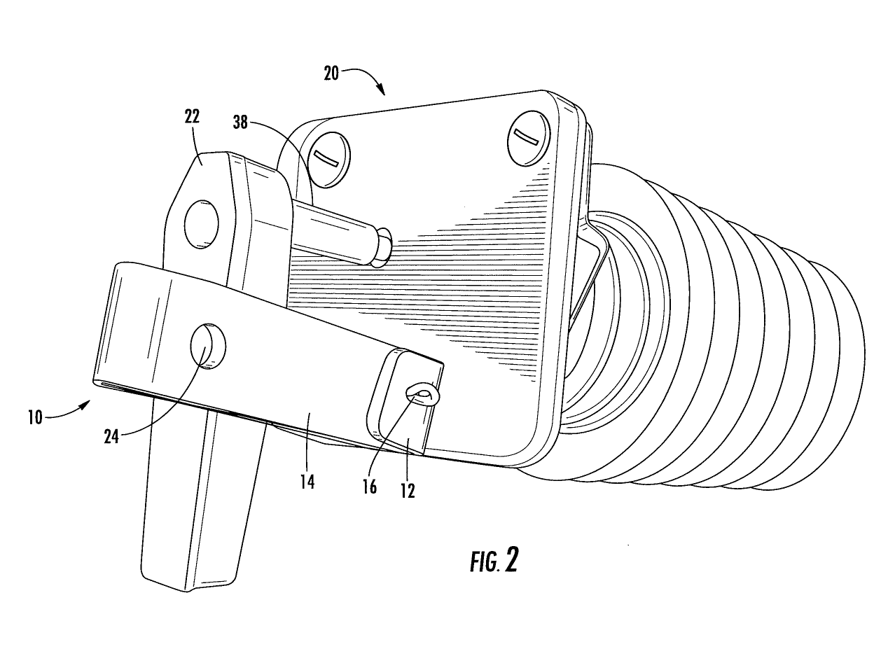

As shown in FIG. 2, the pivoting member 14 should at least be of sufficient length to be able to swing over handle 22 of electrical control device 20 once the mounting member 12 is secured into place on the electrical control device 20. The pivoting member 14 can be a U-shape, where, when in a locking position, the handle 22 of the electrical control device 20 is located within “U” of the pivoting member 14 of the lock 10. Other shapes that allow for such an arrangement are also contemplated, such as a square or V-shape or the like. The lock 10 may be constructed from metal, wood, plastic, or any suitably rigid material, or any combination of suitably rigid materials. Suitably rigid means to be of sufficient strength to withstand being mounted on electrical control device 20 and to be of sufficient strength to support the shackle of a padlock being disposed in apertures 24, as described below.

The pivoting member contains apertures 24 for receiving the shackle of a padlock used to further secure the handle 22 of the electrical control device 20. When the shackle of a padlock is disposed within the apertures 24, the shackle will effectively shorten the length of the pivoting member 14 so that the pivoting member 14 cannot be moved in such a way as to fully free the handle 22. In other words, if someone attempts to move the pivoting member 14 during a lockout, the handle 22 and shackle will interfere with one another and prevent full release of the handle 22 from the pivoting member 14, which, in turn, will prevent them from being able to push in and turn the handle to close the circuit.

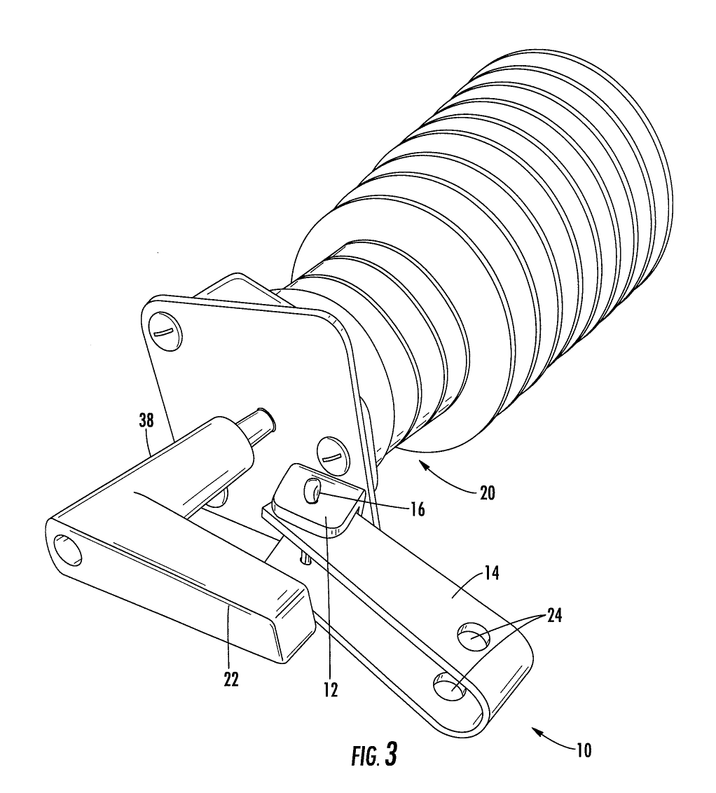

FIG. 3 shows the lock 10 mounted on an electrical control device 20 in a disengaged or unlocked position. Here, the mounting member 12 is attached to the electrical control device 20 as in FIG. 2, but the pivoting member 14 is rotated around the pin 16 and is now in a disengaged or unlocked position. In this situation, the handle 22 of the electrical control device can be freely turned or pushed in or pulled out.

The benefits of this embodiment include that it is relatively simple and inexpensive to manufacture and relatively easy to retrofit onto already existing electrical control devices with the aid of a simple screw or other means of attachment. Once installed, use of the lock described in this embodiment only requires the user to carry their own padlock, or other means of securing the lock, for the lock to function.

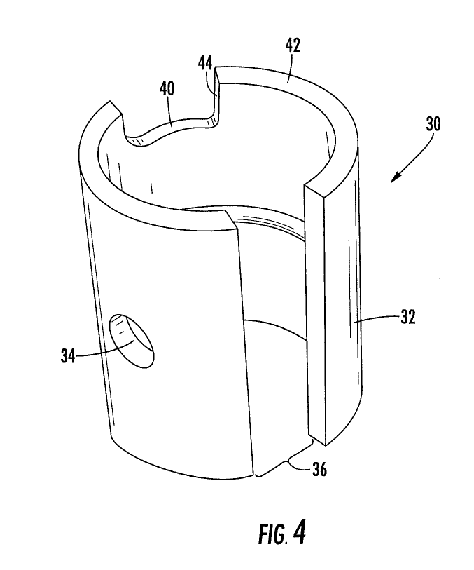

FIG. 4 shows an alternative embodiment of a position lock to be used in accordance with the present invention. The lock 30 may be constructed from metal, wood, plastic, or any suitably rigid material, or any combination of suitably rigid materials. Suitably rigid means to be of sufficient strength to support the shackle of a padlock being disposed in apertures 34. The lock 30 is a tube 32.

The cross-section of the tube 32 is irrelevant, but as shown here the tube 32 is cylindrical. The lock 30 may be unitary or made from one or more parts joined together. When in place, the lock 30 must be of sufficient height to prevent the handle 22 of the electrical control device 20 from being pushed in and closing the circuit.

As shown in FIG. 4, the lock 30 has a slit 36 through one portion of the wall of the tube 32. The slit 36 should extend through the entire length of the tube 32 and should be of a width that allows for the extending portion 38 (shown in FIGS. 2, 3, and 6) of the handle 22 of the electrical control device 20 to pass through the slit 36.

As mentioned above, the lock 30 contains apertures 34 for receiving the shackle of a padlock used to secure the extending portion 38 of the handle 22 of the electrical control device 20 within the lock 30. When the shackle of a padlock is disposed within the apertures 34, the shackle will create a barricade between the extending portion 38 of the handle 22 and the slit 36, so that the lock 30 is effectively incapable of being removed from the electrical control device 20 without removal of the shackle. Therefore, if someone attempts to push in the handle 22 during a lockout which might, for example, restore electricity to the circuit, the handle 22 and the lock 30 will interfere with one another and prevent the handle 22 from being pushed in and closing the circuit.

An additional level of safety can be added if the lock 30 is constructed with a notch 40 disposed in the edge 42 of the tube 32. The notch 40 is designed to give the handle 22 a resting place when in a locked position, such that the handle 22 cannot be turned because the upstanding edges 44 of the notch 40 block the rotational movement of the handle 22. The height of the upstanding edges 44 is not particularly relevant, but should not extend through the entire length of the tube 30 so as to create a slit.

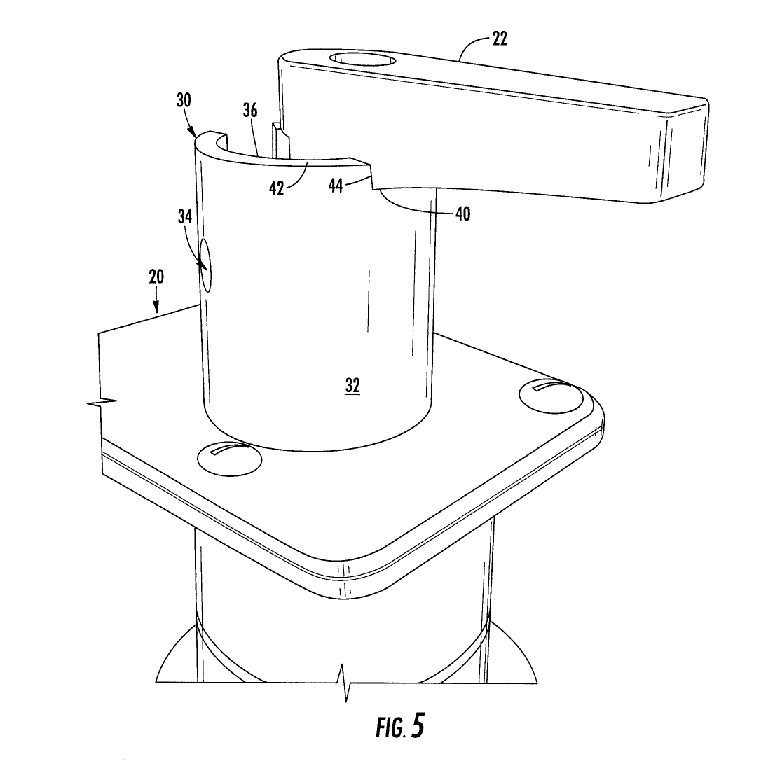

FIG. 5 shows the lock 30 in place on an electrical control device 20. The handle 22 is resting in the notch 40. The extending portion 38 (not visible) of the handle 22 has been passed through the slit 36.

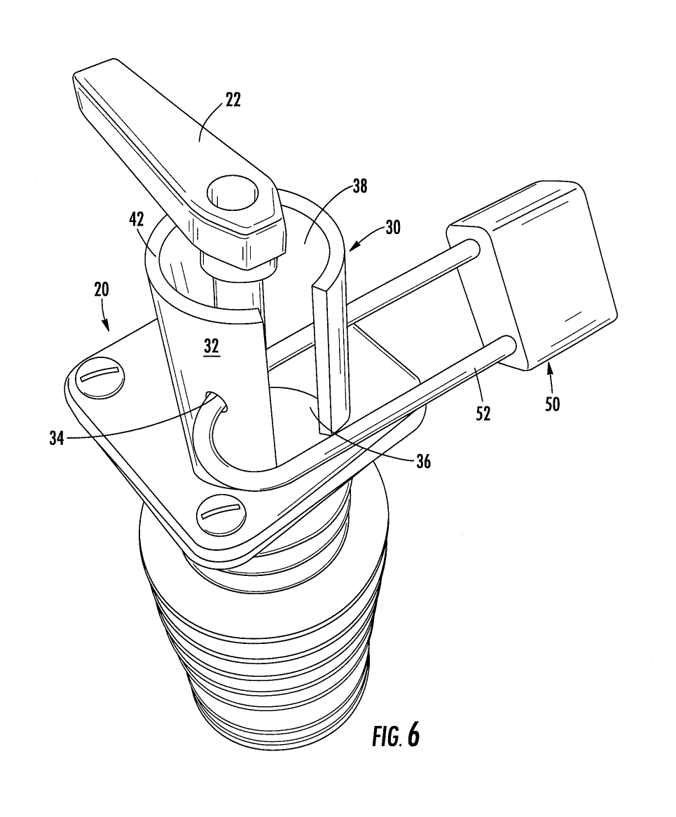

FIG. 6 shows a different perspective of the assembly of lock 30 and electrical control device 20 of FIG. 5, with a padlock 50 securing the lock 30 in position. The shackles 52 of the padlock 50 pass through the apertures 34, thereby creating a barricade between the extending portion 38 of the handle 22 and the slit 36, so that the lock 30 is effectively incapable of being removed without removal of the shackle 52. The design of the position lock 30 prevents the handle 22, once in an OFF position, from turning or being able to be pushed in.

The benefits of this embodiment include that it is simple and inexpensive to manufacture. Also, it does not require any retrofitting and can be used with many commonly used electrical control devices. A maintenance worker need only carry the lock as described in the embodiment with a padlock and can proceed to work without much expense or logistical problems.

Although the term padlock is used throughout as an example of a way to secure the position locks of the invention in place, any suitable means for securing the position locks of the invention in place can substitute for a padlock. This might include cable ties or other types of locks other than padlocks.

In accordance with the provisions of the patent statutes, the present invention has been described in what is considered to represent its preferred embodiments. However, it should be noted that the invention can be practiced otherwise than as specifically illustrated and described without departing from its spirit or scope.

What is claimed is:

1. A position lock for an electric control device comprising:
a. a mounting member;
b. a pivoting member, and
c. apertures for receiving a shackle of a padlock disposed within the pivoting member,
wherein the pivoting member can rotate along a single axis in relation to the mounting member.

2. The lock of claim 1, wherein the pivoting member is U-shaped.

3. The lock of claim 2, wherein the pivoting member is of a sufficient length to be able to swing over handle of device being locked.

4. A position lock for an electric control device comprising:
a. a tubular portion;
b. a slit; and
c. apertures for receiving a shackle of a padlock.

5. The lock of claim 4, wherein the tubular portion further comprises a notch for receiving the handle of the device being locked.

6. A method of locking the handle of an electrical control device in a desired position utilizing the device of claim 1.

7. A method of locking the handle of an electrical control device in a desired position utilizing the device of claim 4.
